(19) United States
(12) Patent Application Publication
(10) Pub. No.: US 2009/0027351 A1
(43) Pub. Date: Jan. 29, 2009

(54) FINGER ID BASED ACTIONS IN INTERACTIVE USER INTERFACE

(75) Inventors: Chunhui Zhang, Beijing (CN); Jian Wang, Beijing (CN)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 12/142,669

(22) Filed: Jun. 19, 2008

Related U.S. Application Data
(63) Continuation of application No. 11/110,442, filed on Apr. 20, 2005.

(51) Int. Cl. G06F 3/041; G06K 9/62

(52) U.S. Cl. 345/173; 382/124

(57) ABSTRACT

A system and method for using biometric images is disclosed. In an embodiment, a plurality of biometric images belonging to an individual are scanned and associated with one or more functions. The user can cause different biometric images to be scanned so that different functions within the user interface can be actuated. Thus, a biometric sensor can be used to provide additional functionality as compared to system where a single biometric image is used to provide access.

### BACKGROUND OF THE INVENTION

1. Field of the Invention

The present invention relates to the field of biometrics; more particularly to the field of using biometric indicia to cause applications to perform functions.

2. Description of Related Art

The use of biometric readers for security purposes is known. Due to the difficulty in remembering passwords and the problems associated with resetting forgotten passwords, users are increasingly relying on the use of biometric data to act as a security key. For example, a user may gain access to a device or a program running on the device by having a biometric sensor scan the user's biometric image. A security program may compare the user's biometric data to compare to data stored in a database to determine whether the user should be granted access.

As is known, a fingerprint, which is one example of a biometric image, has a number of ridges and valleys that form what is referred to as a fingerprint pattern for the finger. Due to genetic and environmental factors, no two fingerprints are alike and the fingerprints of an individual vary from finger to finger. Biometric sensors measure an array that represents small sections of area, known as pixels, on the biometric sensor's platen. By known techniques, the determination of whether a ridge or valley is over a particular section of the sensor allows a pattern to be formed that represents the fingerprint image. This pattern is typically broken down into points that represent features of the fingerprint image and the overall pattern formed by the combination of points provides a data set that may be used to compare to a second data set so as to determine whether the two data sets represent the same fingerprint. The points of interest in the pattern are referred to as minutiae.

Thus, by measuring the minutiae of an individual's finger, a date set representative of the individual's fingerprint may be formed. By comparing two different data sets, a determination may be made regarding whether there is a match between the scanned data set and the stored data set. Typically the match is not perfect because of the fact that fingers are formed of flexible skin and the pressing down of a finger onto a sensor platen is likely to introduce local distortion that will vary depending on how the user pushes the finger on the platen. If the scanned and stored data sets are the same (or within a predetermined tolerance level), the user is recognized and granted access.

While effective in reducing the need for passwords, a pure biometric system is not completely secure. As is known, it is possible to fool certain biometric sensors with simulations of the desired biometric image. In addition, as a general rule it is more secure to require the user to both have something and know something in order to access a system. Thus, banks require users to both have an ATM card and know a pin number in order to provide a greater measure of security. Some login systems include a device that has a changing password synchronized with a changing password on a server. The user uses the password on the device in combination with a known additional static password to access the system. However, both of the above systems require the provision of an object that the user must take care to not lose.

In addition, providing a biometric sensor for the purpose of providing access to a device, a program or a system does not allow the biometric sensor to be used in an thoroughly effective manner because the sensor is only used for one purpose. This problem is made worse in the case of portable devices. Current portable devices have increasing shrunken in size do to improvements in manufacturing capabilities but limits have been imposed due to the need to provide the user with an ability to interact with the device. The inclusion of a biometric sensor on such a portable device simply exacerbates the issue.

### BRIEF SUMMARY OF THE INVENTION

In an illustrative embodiment, a processing unit, such as is found in a computer, is coupled to a fingerprint sensor. The processing unit is coupled to a memory which contains a plurality of stored data sets. The plurality of stored data sets represent a plurality of fingerprint images belonging to a user. Each data set may be associated with a command. The fingerprint sensor may scan in the fingerprint so that a scanned data set can be generated. The processing unit compares the scanned data set to the stored data sets and performs the associated command if a match is found.

### BRIEF DESCRIPTION OF THE DRAWINGS

The present invention is illustrated by way of example and not limited in the accompanying figures in which like reference numerals indicate similar elements and in which:

FIG. 1 illustrates a schematic representation of an exemplary embodiment of a device with a biometric sensor.

FIG. 2 illustrates a simplified schematic representation of a device with a biometric sensor.

FIG. 3 illustrates an embodiment of an algorithm that the devices depicted in FIGS. 1 and 2 could follow.

FIG. 4 illustrates an embodiment of a scan of a fingerprint by an array sensor.

FIG. 5 illustrates an embodiment of a scan of a fingerprint by a sweep sensor.

FIG. 6 illustrates an embodiment of an algorithm for determining a region of interest (“ROI”)

FIG. 7 illustrates a selected pixel form a scanned image.

FIG. 8 illustrates an area surrounding the selected pixel of FIG. 8.

FIG. 9 illustrates an embodiment of forming an ROI.

FIG. 10 illustrates an embodiment of a ROI on an imaged scanned by an array sensor.

FIG. 11 illustrates an embodiment of an array sensor divided into 9 regions.

FIG. 12 illustrates a centroid location on the array sensor depicted in FIG. 11.

FIG. 13 illustrates an embodiment of a change in position of a centroid.

FIG. 14 illustrates an example of a sweep sensor providing scrolling functionality.

FIG. 15 illustrates an embodiment of an algorithm that may be used to determine the change in the position of a fingerprint on a sweep sensor.

FIG. 16 illustrates an exemplary embodiment of an algorithm that may be used to determine the position of a finger on a sweep sensor.

FIG. 17 illustrates an embodiment of a sweep sensor sub-divided into three regions.

FIG. 18 illustrates the location of the fingerprint on the sweep sensor depicted in FIG. 17.

FIG. 19 illustrates an embodiment of a first orientation of a scanned fingerprint

FIG. 20 illustrates an embodiment of a second orientation of a scanned fingerprint.

FIG. 21 illustrates a fingerprint at a first orientation.

FIG. 22 illustrates the fingerprint of FIG. 21 at a second orientation.

FIG. 23 illustrates an exemplary embodiment of an algorithm for determining the change in orientation of a fingerprint.

FIG. 24 illustrates an exemplary embodiment of an algorithm that may be used to determining whether a user is pressing down on a platen.

### DETAILED DESCRIPTION OF THE INVENTION

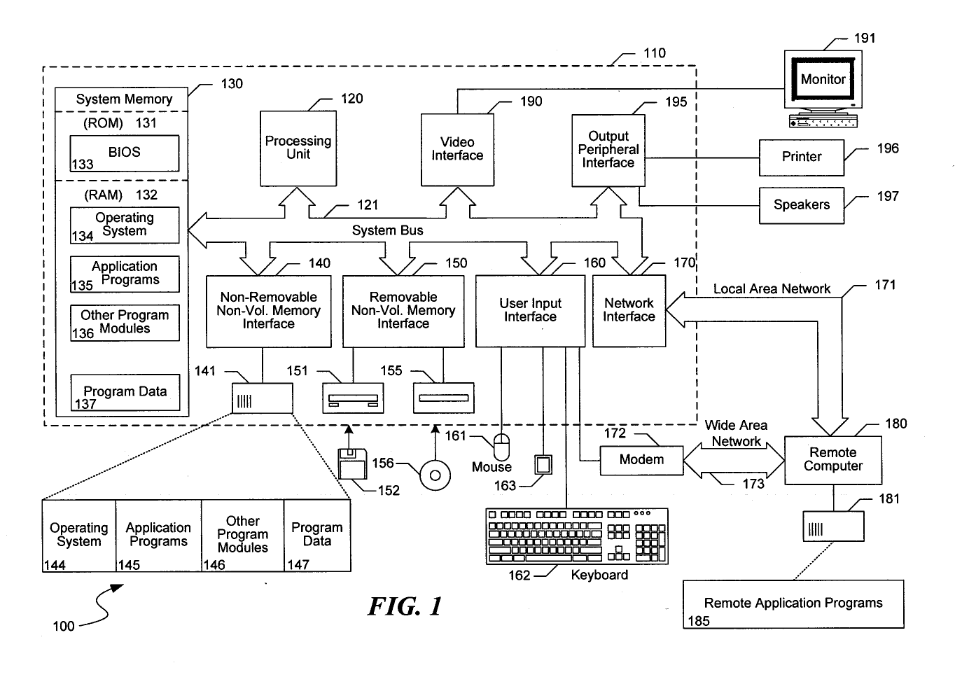

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, and removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

It should be noted program modules typically perform an action in response to a command. The command may be something relatively simple such as providing a value or an instruction or more complex such as a request to perform a series of steps.

As can be discerned from FIG. 1, a biometric sensor 163, which is depicted as a fingerprint sensor, is shown coupled to the user input interface 160. The biometric sensor 163 is configured to scan in biometric data from the user. While shown separately, the biometric sensor 163 may be combined with one of the other input devices such as the keyboard 162 or the pointing device 161. While not so limited, the use of fingerprints may be advantageous in certain situations because a user may cause the biometric sensor 163 to scan fingerprints with relative ease and, in general, a fingerprint sensor may be packaged in a relatively small area.

If the biometric sensor 163 is a fingerprint sensor it may be any known fingerprint sensor suitable for scanning in the user's fingerprints. Examples include optical-based sensors, capacitance-based sensors and thermal-based sensors, where the sensor is configured to scan a user's fingerprints. In addition, the fingerprint sensor may be an array sensor configured to scan at least a substantial portion of the user's fingerprint in a single scan or a sweep sensor configured to scan a portion of the user's fingerprint at a time.

The user can cause the biometric sensor 163 to scan the user's fingerprint. This could be done by placing a finger on a sensor's platen so the fingerprint could be scanned. The biometric sensor 163 scans the fingerprint and forms a scanned data set representative of the fingerprint. The system memory, which may be a memory module located locally, located remotely, or some combination of a local and remote location, may contain stored data sets associated with commands. The processing unit 120 receives the scanned data set and can then compare the scanned data set to the stored data sets within the system memory 130.

It should be noted that the data set could be a set of minutiae that may be arranged around a reference point or the data set could be the entire biometric pattern, such as an entire fingerprint image. The data set could also be some combination of actual image and reference points. As noted above, generally the data set is a representation of the biometric image, both to improve the ability to match to images and to protect the individual's privacy.

If a match is found, the processing unit 120 may perform an action based on an associated command. The command may be something relatively simple such as providing a value or an instruction to a program module or may be more complex such as a request for a program module to perform a series of steps.

Thus, for example, the user could use a thumbprint to open an application and a pinkie fingerprint to close the application. Additional examples will be provided below. In addition, an example of an algorithm for scanning a fingerprint will also be discussed below. However, known algorithms of scanning fingerprints may be used.

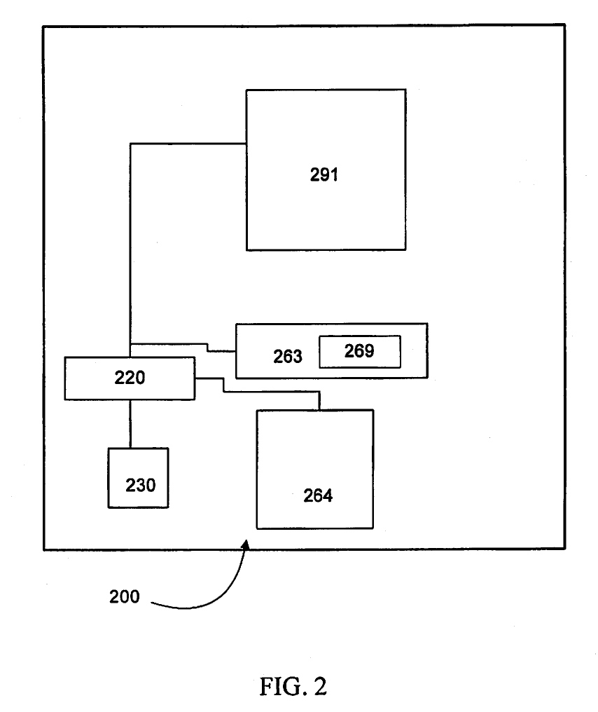

FIG. 2 illustrates a schematic depiction of an embodiment of a portable device 200.

The device 200 includes a fingerprint sensor 263 that is an embodiment of the biometric sensor 163. The fingerprint sensor 263 may include a platen 269. The device 200, as depicted, also includes a display 291 and an input pad 264. Within the device, the processing unit 220 is coupled to the fingerprint sensor 263 and to the memory module 230. It should be noted that while the processing unit 220 (which can be referred to as a CPU) and the memory array 230 are depicted locally (i.e. inside the device 200), they may be partially or completely located remotely and the coupling may be fully or partially via a wireless connection.

The input pad 264 may be a switch such as an actuation button or a 5-way navigation button or something more complex such as a numerical key pad or a qwerty keyboard.

In addition, while depicted in one location, the input pad 264 may consist of multiple switches distributed about the periphery of the device 200.

Thus, one embodiment (not shown) of the device 200 could be a cellular phone equipped with the display 291, the fingerprint sensor 263 and the input pad 264 consisting of a power button and a function switch. The user could turn the phone on and off with the power button and could dial numbers by associating numbers with different fingerprints. Thus, to dial a number not programmed in the phone, the user could press the appropriate finger on the scanner so as to enter the associated number.

This could allow the size of the phone to be decreased without concern about the size of a keypad. To allow for further reductions in size, the fingerprint sensor 263 could be a sweep sensor.

Other portable devices such as media players, portable game machines and the like could similarly benefit from such a reduction in size. For example, the reduction in size of the input pad 264 could allow for a larger display 291 while still maintaining a compact size desired by the user of the product.

Referring to FIGS. 1-2, regardless of the device being used, a user could actuate different programs by causing the biometric sensor 163 to scan different fingerprints. Thus, an index finger could open or switch to a first program, a middle finger could open or switch to a second program, a ring finger could open or switch to a third program and a thumb could close the program currently being used.

In addition, once a program is opened, different fingers could provide different functions within the program. For example, in a video game the different fingerprints could acts as short cuts to different actions. Furthermore, the different fingerprints could be assigned to different macros so that more complex functions could be performed by the user when the user caused the biometric sensor 163 to scan one of the user's fingerprints. In addition, by causing the biometric sensor 163 to scan the fingerprints in a certain order, additional functionality could be provided.

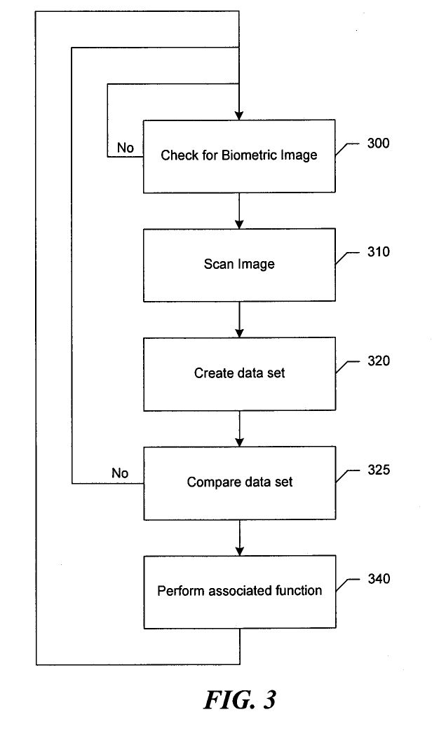

FIG. 3 illustrates an embodiment of an algorithm that the devices depicted in FIGS. 1-2 may follow. First in step 300, the sensor checks to see if a finger has been placed on the platen. For example, a fingerprint sensor may be controlled to sample the fingerprint image periodically. Without a finger on it, the fingerprint sensor will receive an image with a single white color. However, after a user presses a finger on the sensor's acquisition area (e.g. the platen), a fingerprint image may be acquired. By comparing the image acquired to an image taken without a finger on the sensor it is possible to determine whether a finger is on the sensor. The comparison could be a simple average color determination of the scan and comparing the average color to a threshold level of color. An alternative method, if using a capacitive sensor, would be to monitor the change in average capacitance because placing a finger on the platen would change the average capacitance. In an alternative embodiment, a force sensitive sensor would detect the presence of the fingerprint by the change in force applied to the sensor. To avoid undue repetition, whenever scanning a fingerprint is discussed below, the step of checking to see whether there is actually a fingerprint to scan may be included.

Once the presence of the fingerprint is discovered, the sensor then scans the fingerprint in step 310. In step 320, the image is converted into a scanned data set. The scanned data set may be formed in a known manner and may use some of the methods discussed below. In step 325, the scanned data set is compared to the stored data sets in the database to determine whether the scanned data set matches a stored data set that is associated with some value or function. If not, step 300 may be repeated. If the scanned data set matches a stored data set, the task associated with the stored data set is performed in step 340.

In addition to providing the ability to access different functions based on scanning different fingerprints, singularly or in sequence, the sensor may provide additional functionality. In order to provide some of this functionality, it is useful to detect additional features of the biometric image.

On such feature is a region of interest (“ROI”). In addition to the ROI, a centroid of the ROI and an orientation of the fingerprint may be determined. By using these features, additional functionality may be provided by the fingerprint sensor.

For a platen configured to measure a fingerprint, the sensor will typically measure an array that is at least 256 by 300 pixels at a resolution of 500 dpi. To provide greater accuracy, a 500 by 500 pixel array having a 500 dpi resolution could be provided. Naturally, increasing the resolution and the size tends to increase the cost of the biometric sensor and also tends to increase the computational workload as more pixels must be evaluated when the resolution increases.

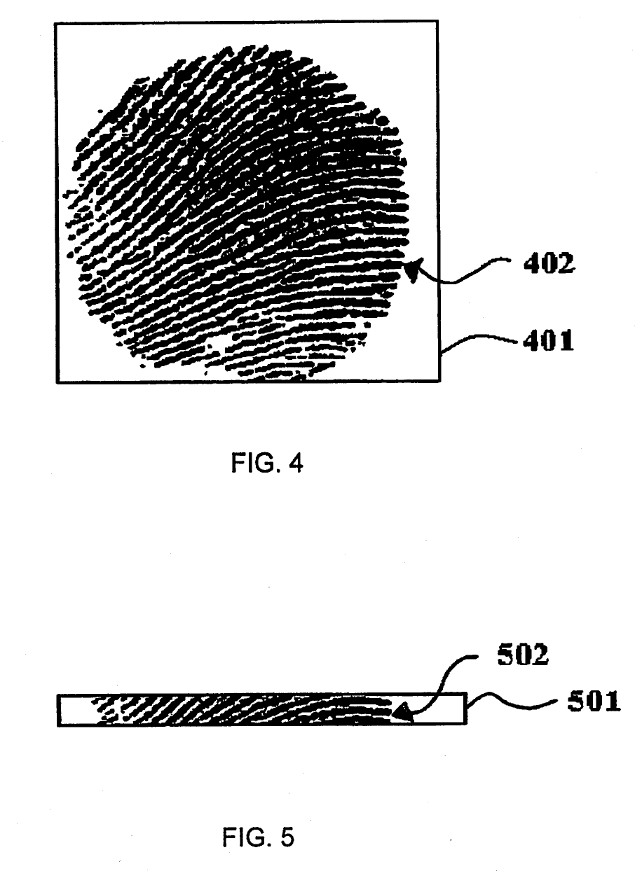

FIG. 4 illustrates an example of a fingerprint image taken with a fingerprint sensor. The scanned area 401 includes a fingerprint 402. As can be appreciated, the scanned fingerprint image includes portions that do not include any actual fingerprint image information. Depending on the size of the sensor, the fingerprint will take up a greater or lesser percentage of the overall scanned image. Thus, it would seem beneficial to make the size of the sensor just large enough to scan a fingerprint so as to avoid the need to compare and store additional pixels. However, there are certain advantages of having a larger sensor that will be discussed below.

FIG. 5 is representative of an image captured by a sweep sensor such as one having an 8 pixel by 500 pixel array with a 500 dpi resolution. The scanned area 501 includes a fingerprint portion 502. Other embodiments of sweep sensors are possible, such as an 8 pixel by 256 pixel sweep sensor at a similar resolution. As with the image depicted in FIG. 4, the image of FIG. 5 contains pixels on the left and right side of the fingerprint portion 502 that do not contain information about the fingerprint image.

Once an image is captured by the fingerprint sensor, the image may be analyzed. Existing techniques for determining the location and orientation of the minutiae may be used so that a data set can be generated for comparison with data sets stored in a database. However, with a larger sensor size, it would be beneficial to minimize the pixels that need to be considered. To aid in this manner, a region of interest (ROI) may be determined.

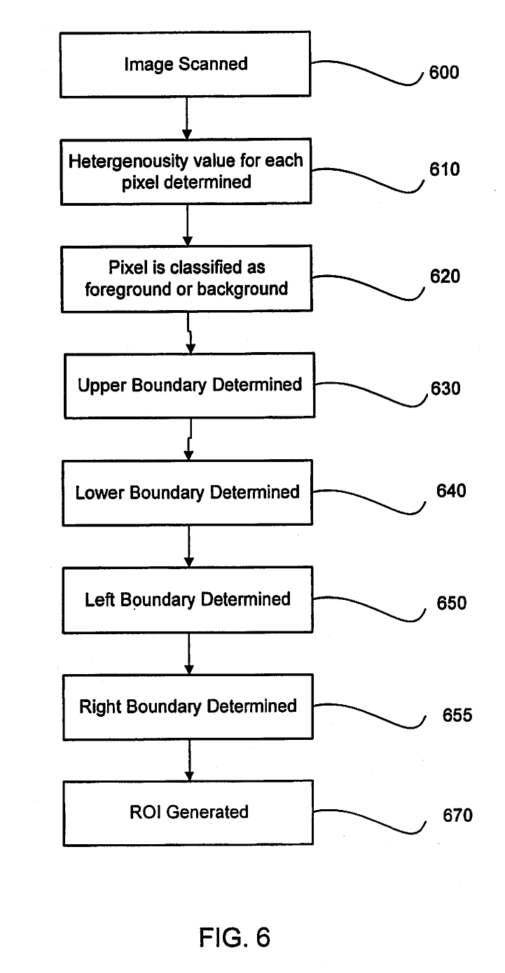

FIG. 6 depicts a flow chart of an exemplary method of determining the ROI. First, in step 600 the fingerprint image is scanned. As noted above, this step may include a verification that a finger is actually on the sensor platen. FIG. 4 is an exemplary embodiment of the results of step 600, depicting the scanned area 401 with a fingerprint image 402 on it.

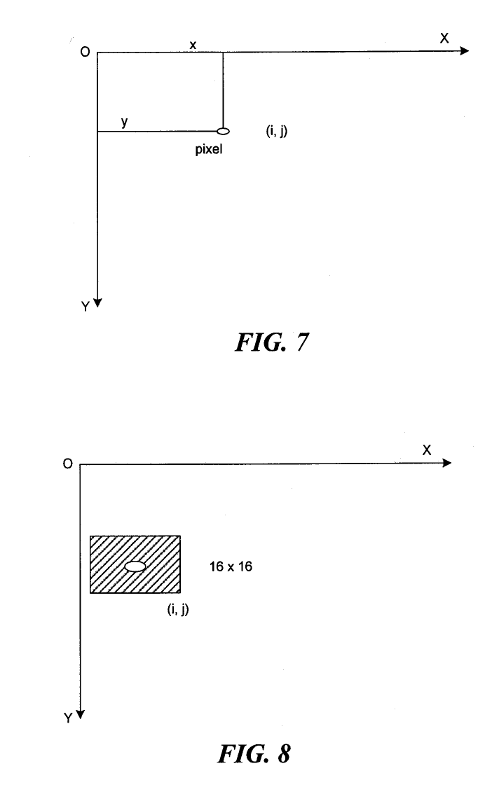

Next, in step 610 the heterogenousity value for each pixel is determined. First the scanned image is placed on a coordinate chart. Assuming a particular pixel can be represented as by the coordinates (i, j), then I(i, j) represents the intensity of a particular pixel. FIG. 7 illustrates a pixel being considered. By looking at the neighboring pixels in a w by w region about the pixel (i, j), where w is 16, the heterogenousity value may be determined. An example of this is depicted in FIG. 8. First the mean heterogenousity, μ for pixel (i, j) may be determined with the following equation:

$${μ}_{i , j} = \frac{{\sum }_{m = - w / 2}^{w / 2 - 1} {\sum }_{n = - w / 2}^{w / 2 - 1} I ( i + m , j + n )}{w \times w}$$

Next, the variance σ for the pixel (i, j) may be calculated as follows:

$${σ}_{i , j}^{2} = \frac{{\sum }_{m = - w / 2}^{w / 2 - 1} {\sum }_{n = - w / 2}^{w / 2 - 1} {( I ( i + m , j + n ) - {μ}_{i , j} )}^{2}}{( w \times w - 1 )}$$

This variance σ_{i,j} may then be used as the heterogenousity value of the pixel (i, j). This process is done for each pixel. Naturally, the above equations may be varied to cover different regions, for example n and m could range from −w/2+1→w/2. In addition, w need not be 16.

In step 620, the heterogenousity value is compared to a threshold value. If the heterogenousity value is larger than the threshold value, the pixel is classified as a foreground (or fingerprint) pixel. Otherwise, the pixel is classified as a background pixel. This step is repeated for each pixel.

It should be noted that the step of determining whether each pixel is a foreground or background pixel may be accomplished immediately after the pixel's heterogenousity value is determined and it may be done after the heterogenousity value is determined for all the pixels or some combination thereof.

Once the pixels have been classified, in step 630 an upper boundary may be determined. The number of foreground pixels in the top row is determined and compared to a threshold value. If the top row does not meet the threshold value, the next row is evaluated. This process continues until a row is found that has the number of foreground pixels equal to the threshold value. That row becomes the upper boundary row for the ROI.

In step 640, the process used in step 630 is repeated except the process starts from the bottom row and moves upward. Once a threshold value is reached, the lower boundary row is determined. In steps 650 the same process is used except the number of foreground pixels in the left most column are compared to a threshold value. As before, successive columns of pixels from left to rights are evaluated until a column is found that equals the threshold value and that column is the left boundary. In step 655, the process used in step 650 is repeated except the right-most column is used as a starting point and the process moves from right to left.

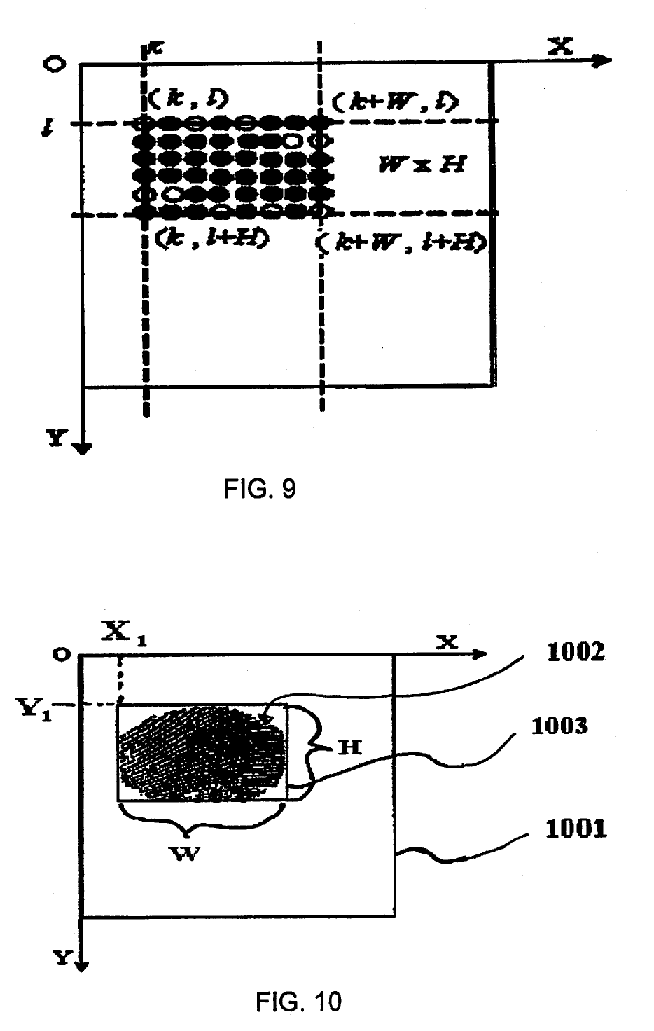

FIG. 9 illustrates a fingerprint with the four boundary lines l, l+H, k and k+W. Once the four boundaries are determined, in step 670 a ROI is generated. FIG. 10 illustrates a fingerprint image 1002 (similar to fingerprint image 402 of FIG. 4) bounded by the ROI 1003. As can be appreciated, the scanned area 1001 is larger than the ROI 1003, thus the ROI 1003 allows the remainder of the scanned area 1001 to be ignored. The image within the ROI 1003 may be used in known ways to develop the data set as discussed above. In addition, the ROI 1003 may be used for additional purposes which will be discussed below.

Modifications to the algorithm depicted in FIG. 6 may be made. For example, all the pixels in the first row could be classified and the number of foreground pixels in the row could be compared to a threshold number to determine whether the row was a row of interest. The first row that equaled the threshold would be the upper boundary row. Next the lower boundary could be determined. Once the upper and lower boundaries were determined, the left and right boundary determination would not look above the upper boundary or below the lower boundary. This could potentially reduce the number of pixels that needed to be evaluated. A similar modification starting with the left and right boundaries could also be done.

Once the ROI is determined, the centroid of the ROI may be determined. For example, the position of the centroid (mₓ, m_{y}) may be determined with the following equations:

$${m}_{x} = \frac{{\sum }_{m = X}^{X + W} {\sum }_{n = Y}^{Y + H} I ( m , n ) * m}{W * H}$$

$${m}_{y} = \frac{{\sum }_{m = X}^{X + W} {\sum }_{n = Y}^{Y + H} I ( m , n ) * n}{W * H}$$

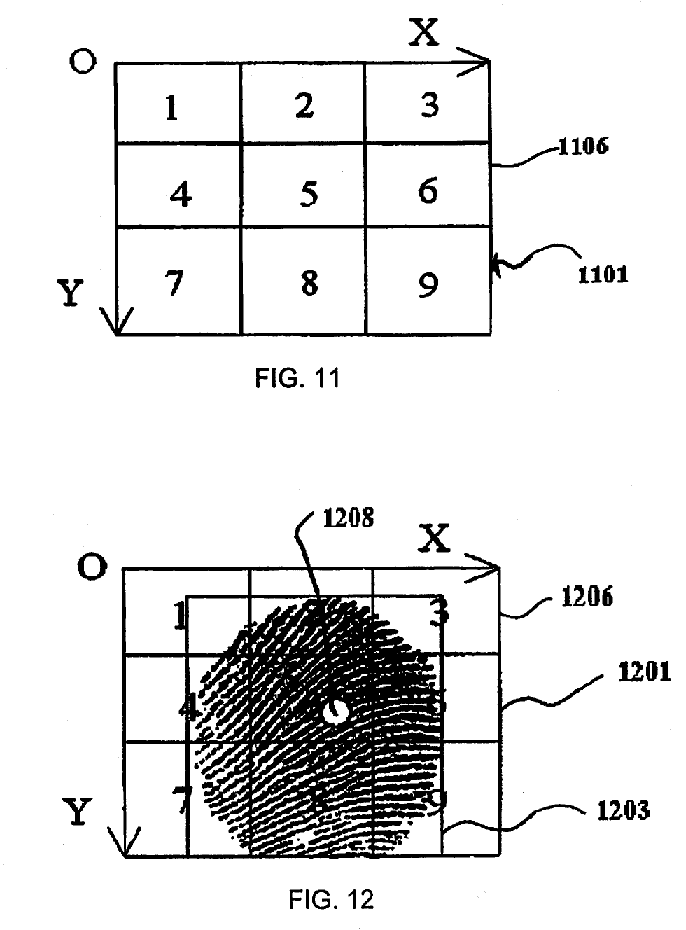

In the above equations, X is the location of the left boundary line, Y is the location of the upper boundary line and W and H are the width and height of the ROI as depicted in FIG. 11. The centroid (mₓ, m_{y}) provides the absolute location of the fingerprint and the location of the centroid may be used to provide several functions.

One function that may be provided with the centroid is that the fingerprint reader may act as a keypad. For example, as shown in FIG. 11, the scanned area 1101 may be sub divided into 9 regions 1106. Once a fingerprint is placed on the platen, the centroid may be determined. Depending on which region the centroid is located in, a different value is provided. Thus, in FIG. 12, the scanned area 1201 (similar to the scanned area 1101) is divided into 9 regions 1026 and the ROI 1203 is used to determine that the centroid 1208 is located in region 1206 assigned the value 5. This could allow the fingerprint scanner to act as a keypad for entering in numbers for a calculator or dialing phone numbers or the like. As only the values 1-9 are provided in the depicted example, the number zero could be provided by activating a switch.

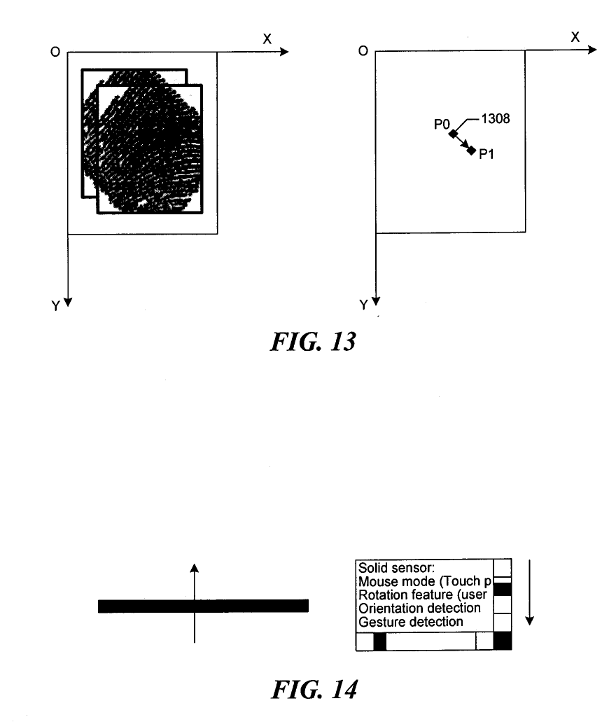

In addition, the ability to determine the centroid may allow the sensor to acts as a touch pad. By periodic sampling, the location of the centroid may be determined. If the location of the centroid changes over time, the change in location of the centroid may be used to move a cursor in the user interface. FIG. 13 illustrates such an embodiment. The centroid 1080 moves from the position P₀ to the position P₁. The cursor on a display screen may be moved in a similar manner so the fingerprint sensor operates as a touch pad as well as a sensor. This allows the sensor to be more fully utilized and reduces the need to provide multiple pieces of hardware that provide similar functionality.

The ability to locate the centroid may also allow the fingerprint sensor to function as a pointing device such as is found on many laptops. To provide this functionality, the location of the centroid is determined as discussed above. This location is compared to the center of the sensor. The distance between the centroid and the actual center may act as the equivalent to the amount of force being applied to a pointing device, thus a larger difference would simulate a hard push and provide a relatively fast movement of the cursor. If the centroid was near the center of the sensor, the cursor could move relatively slowly. In this manner, a fingerprint sensor could act as the pointer or an analog joystick.

Furthermore, the ability to find the location of the centroid also allows the sensor to track the change in position so as to detect more complex gestures. Thus, clockwise motion could open a program while a counter-clockwise program could close the program. More complex gestures could also be detected as desired and the different gestures could be assigned to different commands.

Referring back to FIG. 5, a sweep sensor may be used to scan a user's fingerprints as well. In addition to provide the functionality of determining which finger is being scanned and whether there is any functionality associated with the particular fingerprint as discussed above, the sweep sensor may act as a navigation button similar to a tilting scroll wheel. The sensor may be configured to periodically sample an image. When the sensor determines that a finger is being slid over the sensor, the velocity of the finger and the direction may be used to provide the functionality of the tilting scroll wheel. Horizontal movement may also be sensed so the sweep sensor may provide left/right movement in addition to up/down movement. For example, as depicted in FIG. 14, the user could slide the finger up across the sweep sensor and cause a corresponding downward movement in the display.

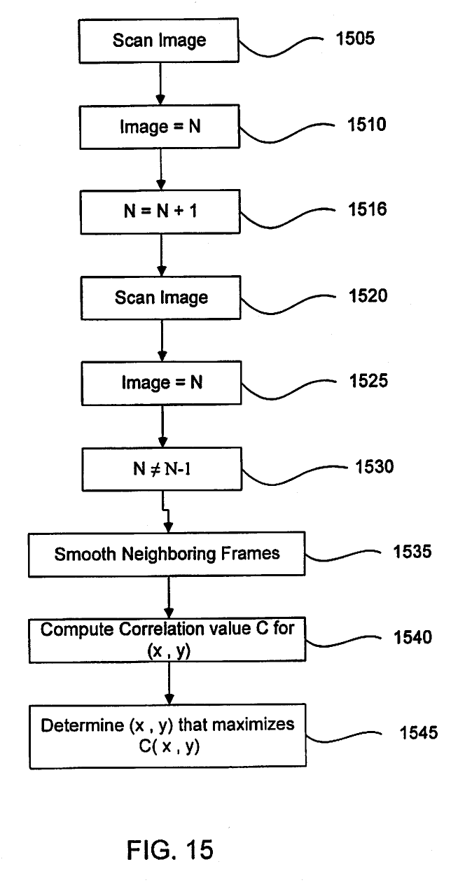

When using a sweep sensor, an image matching method may be used to compute the motion. FIG. 15 illustrates an embodiment of the algorithm that may be used. First in step 1505, an image is scanned. If the image is blank, than step 1505 is repeated. To conserve power, the frequency of scanning during step 1505 may be reduced until a fingerprint is sensed because until a finger is placed on the sensor there is little need for rapid sampling.

Once the sensor senses a finger has been placed on the sensor, the image is saved and set equal to N in step 1510. Next, in step 1516, the value of N is set equal to N plus one. Then in step 1520 another image is scanned. If the image is equal to a blank sensor, step 1505 is repeated. If the image is not blank, in step 1525 the image is set equal to N. Next, in step 1530 image N is compared to image N−1. If the two images are the same, step 1520 is repeated. If the two images are not the same, the algorithm proceeds to step 1535.

In step 1535 the two images are smoothed to reduce noise. Known Gaussian filters may be used to smooth the two images, for example, the following equation may be used where G is a Gaussian filter with a window W×W:

$$S ( i , j ) = {\sum }_{u = i - \frac{W}{2}}^{i + \frac{W}{2}} {\sum }_{j = j - \frac{W}{2}}^{j + \frac{W}{2}} I ( u , v ) \times G ( u + \frac{W}{2} , v + \frac{W}{2} )$$

After the two images are smoothed, the correlation between the two images C may be determined in step 440 via the following formula:

C(x,y)=ΣΣI_{N}(i+x,j+y)×I_{N-1}(i,j)

In the above formula, C represents the correlation value for offset (x, y), and I_{N-1} is the previous image or frame while I_{N} is the current image or frame. Thus, the correlation value of the neighboring images or frames may be determined for different translation offsets.

In step 1545, the maximum value of C is solved for because the translation (x, y) is equal to the value of (x, y) that maximizes the value of C:

$$( x , y ) = {max}_{x , y} C ( x , y )$$

After the translation had been determined, the velocity of the finger's movement may be determined based on the time between samples. The velocity may allow for a more responsive sensor because faster movement of the user's finger may be equated with faster movement of cursor. This relationship could be a linear increase in cursor movement speed or the relationship between increased cursor velocity as the finger velocity increases could be non-linear (e.g. log-based, etc. . . . ). In this manner, a fast movement of the user's finger could move the cursor a greater distance than a slow movement of the user's finger. In an alternative embodiment, the distance moved may be fixedly related to an associated cursor movement. In addition, a combination of the two concepts is possible. For example, the absolute distance traveled may be used for some range of finger velocities but higher finger velocities could provide a different cursor velocity versus finger velocity relationship.

While the velocity and direction of movement may be detected by a sweep sensor, it is somewhat more difficult to detect an absolute location of the finger on the sweep sensor. For example, if the sweep sensor is a 256 by 8 pixel sensor at a 500 dpi resolution, the sensor will typically be smaller than the user's finger. As it may not be possible to determine the centroid, it is often impractical to use the centroid to determine the location of the finger. However, it is possible to determine the location of the finger using statistical methods.

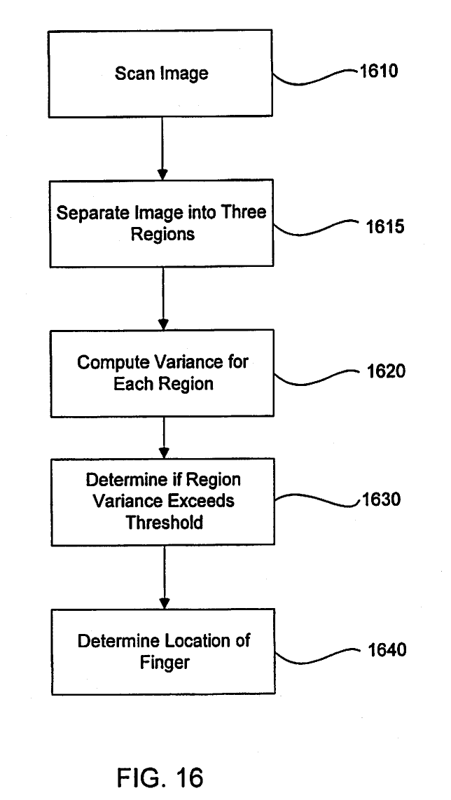

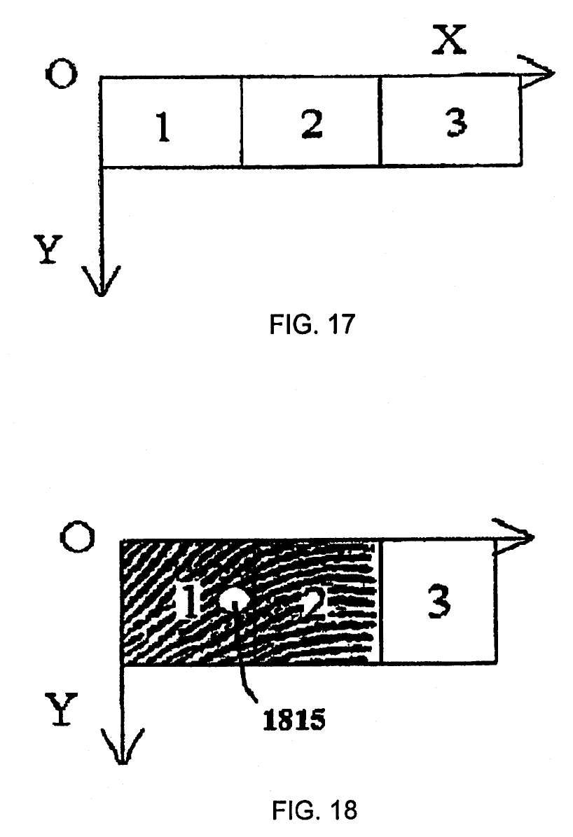

FIG. 16 illustrates an embodiment of an algorithm that may be used to determine the location of a finger on a sweep sensor. First, in step 1610 the sweep sensor scans the image. Next, in step 1615, the scan area is separated into separate regions. For example, in FIG. 17, the scan area 1701 is separated into three separate regions 1702. Next, in step 1620, the variance for each region is determined. This may be accomplished by determining the variance for each pixel as discussed above in FIG. 6 and then determining the average variance for the region. Using statistical methods, a threshold for what represents a finger being positioned on the region may be pre-determined.

In step 1630, the variance of each region is compared to the threshold variance. If the variance any of the regions exceeds the threshold, the left most region may be given the highest weighting, the middle the second highest and the right region the lowest. In an alternative embodiment, the right and left may be given equal priority and the middle region may be given lower priority. Other algorithms are possible. By determining the level of variance, the location of the finger may be ascertained in step 1640. Thus, in FIG. 18 the location of the finger 1815 is determined to be in the first region, not the second or third region.

The ability to separate the sweep sensor into two or more regions allows the sensor to provide additional functionality. For example, by allowing the user to select one of two or more regions, the sweep sensor may provide the functionality of a plurality of soft keys. Furthermore, if the sweep sensor is provided on a mouse, the user could use the two or more regions to control zoom or focus on different displays or in different windows. Thus, a sensor divided into three regions could provide the equivalent of three different scroll wheels in one sweep sensor. In a program, dividing the sensor into two regions could allow the user to use a first side to control the level of zoom and a second side to control scrolling up and down. If three regions were provided, one of the regions could control brightness or some other desired parameter such as horizontal scrolling.

On a device functioning as a media player, the three regions could represent 1 minute, 30 seconds and 5 second intervals and the movement of the finger over one of the regions could cause forwarding or reversing of the media by the appropriate interval. In addition, the sweep sensor could be divided into two regions and used to scroll through albums and songs if the media player was playing music. Numerous similar uses are possible, depending on the device the sweep sensor is mounted on. An advantage of this as compared to a wheel or moving switch is that no moving parts are needed, thus the reliability of the device may be improved.

Furthermore, as the sweep sensor can scan in the fingerprint, using the sweep sensor to provide additional functions allows the device to be made more compactly or more aesthetically pleasing while still providing the ability to provide high levels of security.

As is known, orientation of the fingerprint is important to determining whether two different smays match each other. As noted above, generally the entire fingerprint is not used to compare prints. For one thing, using the entire fingerprint requires the storage of an entire fingerprint and that is generally less desirable from a privacy standpoint. Instead, a data set representing the relative location of the minutia from a scanned image is compared to stored data sets representing the relative location of minutia. In order to compare the different data sets, the orientation of the different data sets may be aligned. One known method of alignment is to determine a reference point for the fingerprint and than compare the location of the other minutia to that reference point. The reference points of two images may be assigned a zero, zero value on a Cartesian coordinate system and the location of the minutia surround the reference points of both scanned images should match up once the orientation of the two data sets are aligned, assuming the two data sets are representations of the same fingerprint.

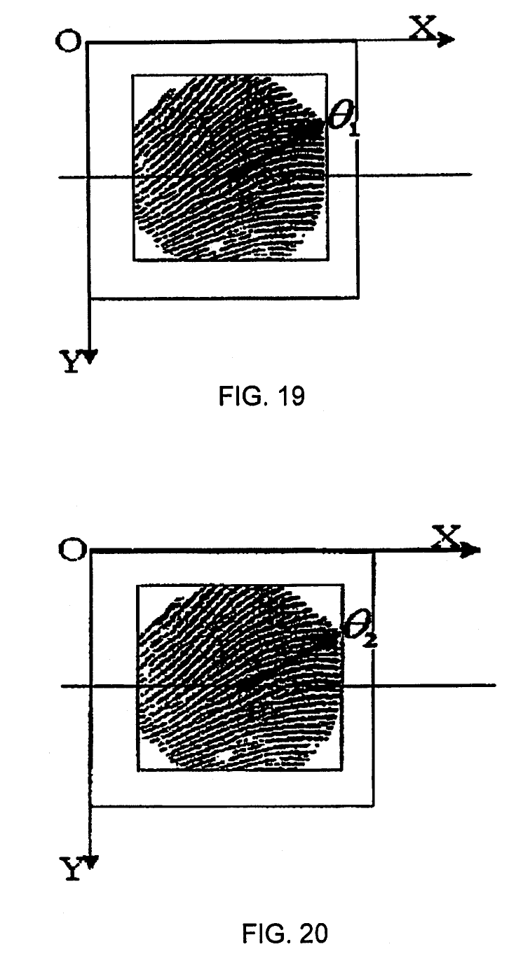

The orientation of a fingerprint may have additional uses as well. For example, if the orientation of a fingerprint is determined, a change in the orientation may provide certain functionality. FIGS. 19 and 20 depict an image with an orientation of θ₁ and θ₂, respectively. By determining the change in orientation, it is possible to determine whether the user is rotating the finger and to provide associated functionality that may be pre-programmed or user determined. Thus, a clockwise rotation could open a program and a counterclockwise rotation could close the program. Furthermore, a particular finger could be associated with a particular application or function so that clockwise rotation of that finger actuates that application or function and counterclockwise rotation stops the application or function. In addition, clockwise rotation of a first finger could actuate a first application and clockwise rotation of a second finger could actuate a second application.

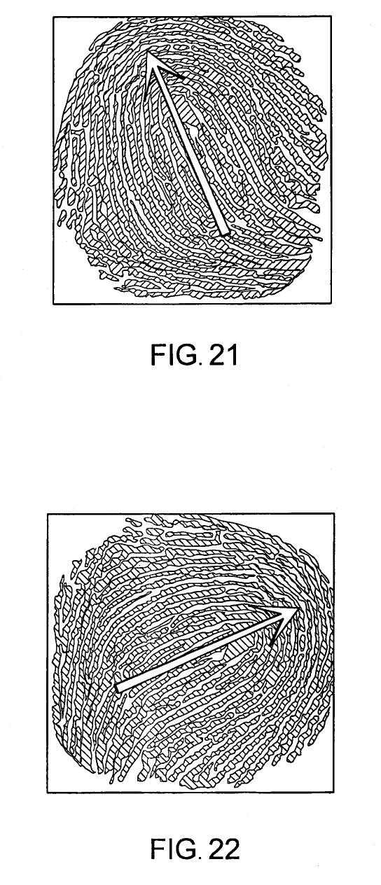

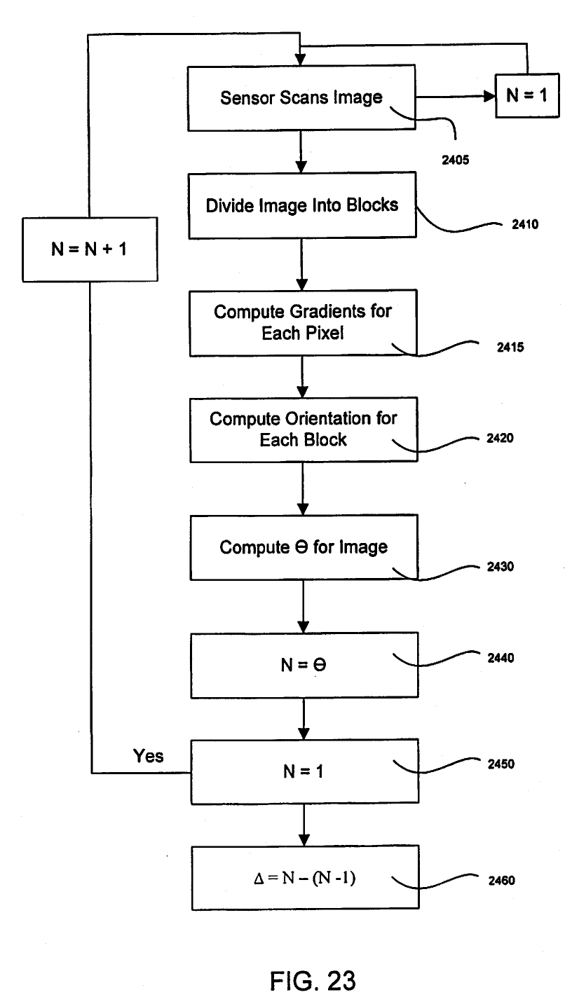

In addition, the rotation of the fingerprint could acts as a steering wheel. Thus, the orientation of the fingerprint depicted in FIG. 21 could be changed to the orientation depicted in FIG. 22 and the result could cause a vehicle in the video game to turn right. While known methods may be used to determine a change in orientation, FIG. 23 illustrates an exemplary algorithm that may be used to determine the orientation of a fingerprint.

First, in step 2405, the sensor scans an image. If the image is blank, in step 2407 N is set equal to 1 and step 2405 is repeated. If the image is not blank, next in step 2410, the image may be divided into blocks of size (W+1) by (W+1) pixels. Next, in step 2415 the gradients Gₓ and G_{y} are computed at each pixel within each of the blocks. A Sobel operator may be adopted to compute the gradients. Next, in step 2420, the orientation θ(i, j) of each block is determined using the following equations:

$${V}_{x} ( i , j ) = {\sum }_{u = i - \frac{w}{2}}^{i + \frac{w}{2}} {\sum }_{j = j - \frac{w}{2}}^{j + \frac{w}{2}} 2 {G}_{x} ( u , v ) {G}_{y} ( u , v )$$

$${V}_{y} ( i , j ) = {\sum }_{u = i - \frac{w}{2}}^{i + \frac{w}{2}} {\sum }_{j = j - \frac{w}{2}}^{j + \frac{w}{2}} ( {G}_{x}^{2} ( u , v ) {G}_{y}^{2} ( u , v ) )$$

$$θ ( i , j ) = \frac{1}{2} {tan}^{- 1} ( \frac{{V}_{x} ( i , j )}{{V}_{y} ( i , j )} )$$

where W is the size of the local window and is equal to 8 and Gx and Gy are the gradient magnitudes in the x and y directions, respectively. In step 2430, an average θ for the entire region may be determined based on the θ(i, j) for each block. The average θ defines the orientation for the current image. The average θ may be defined as originating from the centroid, the computation of which is described above.

In step 2440, the orientation of the current image is set equal to N and in step 2450 N is checked to see if it equals 1. If the answer is yes, in step 2455 N is advanced by 1 and step 2405 is repeated. If the answer is no, in step 2460 the current orientation is compared to the previous orientation and the change in orientation A is computed.

Depending on the frequency of sampling, the Δ may need to be added to previous computations of Δ to determine whether the finger has actually been rotated by the user. Thus, additional steps such as advancing the value of N, storing the total amount of Δ observed during this sampling period, and repeating the algorithm may be desirable. FIGS. 19 and 20 depict two images with orientations θ₁ and θ₂ so that Δ may be determined. If θ₁ and θ₂ are the same, than the finger's orientation has not been changed and Δ will be zero.

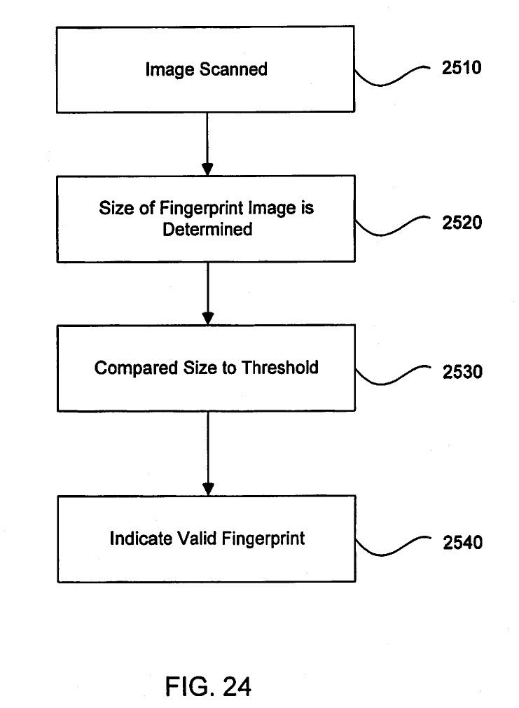

As noted above, the change in average color may be used to determine whether a user's finger has been placed on the sensor's platen. While the color change method will work, the following method depicted in FIG. 24 may provide additional functionality that may be useful.

First, in step 2500, an image is scanned. Next, in step 2510, the size of the fingerprint region is determined. This may be done with the ROI algorithm discussed above in FIG. 6. Next, in step 2520, the computed size of the fingerprint region is compared to a threshold and if the size of the fingerprint region exceeds a threshold value than the image is considered to be of a fingerprint and the user is considered to have placed a finger on the platen. In addition to determining whether to continue with other algorithms that use the scanned image, the above algorithm may provide an on/off switch. The ability to have such an on/off switch allows the sensor to act as a button for activating programs and other software.

While steps 2500 through 2520 are possibly are more computationally intensive than a simple average color check, the results have additional uses. For example, the size of the ROI may be compared to a threshold size to make sure the user is pressing down hard enough. This can help ensure a more consistent fingerprint scan because the fingerprint image changes somewhat depending on how hard the user is pressing down. Thus, if the ROI is too small, the user may be directed to press harder.

In addition, if the user initially presses on the platen gently and then presses harder, the size of the ROI will increase. By measuring the change in ROI over time it is possible to determine if the user is pressing harder so as to allow the sensor to simulate pushing down on a button. This may even provide a level of analog-type control for a button that might normally be more of a binary on/off type switch.

Furthermore, the press-down feature may be combined with other features. For example, a person could place a finger on the sensor, slide it in a direction, and than press down. The response in the program module could be to cause a cursor to highlight a selection in a menu and than chose the selection that was highlighted when the finger was pressed down. Thus, pressing down may simulate a stylus or mouse click or even a double click.

It should be noted that a number of different algorithms and uses for a biometric sensor have been provided. Many of the examples were with respect to a sensor configured to scan fingerprints; however, the ideas are not so limited. These algorithms, ideas and components may be combined in various ways to provide additional functionality.

The present invention has been described in terms of preferred and exemplary embodiments thereof. Numerous other embodiments, modifications and variations within the scope and spirit of the appended claims will occur to persons of ordinary skill in the art from a review of this disclosure.

1-20. (canceled)

21. A system for providing user control, comprising:
a display device;
an input device including a biometric sensor for providing biometric data derived from a fingerprint of a user; and
a processing unit programmed with computer-executable instructions to perform:
receiving from the biometric sensor biometric data sets of a fingerprint that are scanned over time;
for each biometric data set, determining a specific location within the biometric data set;
when the determined specific locations indicate that the finger of the user has moved, moving a cursor on the display device
wherein the user moves a finger across the biometric sensor to control using movement of the cursor on the display device.

22. The system of claim 21 wherein the specific location is a centroid of the fingerprint.

23. The system of claim 21 including determining the speed of movement of the finger and moving the cursor on the display device based on the determined speed.

24. The system of claim 21 including determining distance between a specified location relative to a center of the biometric sensor and using the determined distance as an indication of force being applied to a joystick.

25. The system of claim 21 including determining from the biometric data sets whether the user is applying increased force to the biometric sensor and using a determination that the user is applying an increased force as a selection indicator.

26. The system of claim 25 wherein the determining of whether the user is applying increased force includes determining that the area of a centroid of the biometric data sets has increased.

27. The system of claim 25 including displaying text on the display device and selecting text based on movement of the finger along the biometric sensor followed by application of increased force to the biometric sensor.

28. The system of claim 21 including determining an angle of orientation of the finger relative to the biometric sensor and performing different functions based on the determined angle of orientation.

29. The system of claim 21 including comparing a biometric data set to a stored biometric data set to determine whether the user is authorized to access the system.

30. A computer-readable medium encoded with computer-executable instructions for providing user control of a device with a biometric sensor for inputting biometric data from a fingerprint, by a method comprising:
receiving from the biometric sensor a biometric data set derived from a user placing their finger on the biometric sensor;
determining from the biometric data set an angle of orientation of the finger relative to the biometric sensor; and
performing different functionality based on the determined angle of orientation
wherein the user orients their finger relative to the biometric sensor to control selection of different functionality.

31. The computer-readable medium of claim 30 wherein the determining the angle of rotation includes comparing the received biometric data set to a stored biometric data set associated with a known angle of orientation.

32. The computer-readable medium of claim 30 including determining from successively received biometric data sets whether the user is rotating their finger and when it is determined that the user is rotating their finger, performing different functionality based on direction of rotation.

33. The computer-readable medium of claim 32 wherein the rotation of the finger is used to act in place of a steering wheel.

34. The computer-readable medium of claim 31 including detecting movement of the finger across the biometric sensor and using the detected movement to control movement of a cursor on a display of the device.

35. The computer-readable medium of claim 31 including determining whether an increased force is being applied by the finger to the biometric sensor and using a determination that an increased force is being applied as a selection indicator.

36. A method in a device with a biometric sensor for receiving user input via the biometric sensor, the method comprising:
receiving from the biometric sensor biometric data sets scanned over time from a finger of the user; and
controlling the device based on the received biometric data sets without determining whether the received biometric data sets match a stored biometric data set.

37. The method of claim 36 wherein the device includes a display and the controlling of the device includes detecting movement of the finger on the biometric sensor and moving a cursor displayed on the display based on the detected movement.

38. The method of claim 36 wherein the device includes a display and wherein the controlling of the device includes detecting movement of the finger on the biometric sensor and moving a scroll bar displayed on the display based on the detected movement.

39. The method of claim 38 wherein the biometric sensor is a sweep sensor and different scroll bars are moved based on location of the finger relative to the sweep sensor.

40. The method of claim 36 wherein the controlling of the device includes detecting an increased force being applied to the biometric sensor by the finger.
